(19) United States
(12) Patent Application Publication
(10) Pub. No.: US 2025/0292520 A1
(43) Pub. Date: Sep. 18, 2025

(54) OBJECT TRACKING SYSTEM AND OBJECT TRACKING METHOD

(71) Applicant: WISTRON NEWEB CORPORATION, HSINCHU (TW)

(72) Inventors: LEE AING, HSINCHU (TW); YI-AN CHEN, HSINCHU (TW); HOREN CHEN, HSINCHU (TW); CHIEH-WEN CHENG, HSINCHU (TW); FU-MING KANG, HSINCHU (TW)

(21) Appl. No.: 19/078,409

(22) Filed: Mar. 13, 2025

Related U.S. Application Data
(60) Provisional application No. 63/564,527, filed on Mar. 13, 2024.

(51) Int. Cl. G06T 19/00; G01S 7/41; G01S 13/72; G01S 13/86; G06T 7/246; G06T 7/73

(52) U.S. Cl. CPC G06T 19/006; G01S 7/412; G01S 13/723; G01S 13/867; G06T 7/246; G06T 7/73; G06T 2207/10016; G06T 2207/10048; G06T 2207/20081; G06T 2207/30196

(57) ABSTRACT

An object tracking system and an object tracking method are provided. The object tracking system includes a transmitter, a receiver and a processing circuit. The transmitter is configured to transmit wireless signals through a target space. The receiver is configured to receive the wireless signals. The at least one processing circuit is configured to perform following processes: obtaining the wireless signals received by the receiver; generating motion information associated with at least one target object by executing a motion machine-learning model that processes the received wireless signals; generating three-dimensional tracking information of the at least one target object with respect to the target space by fusing spatial information of the target space and the motion information; and generating at least one augmented reality (AR) object corresponding to the at least one target object in a digital image corresponding to the target space according to the three-dimensional tracking information.

### CROSS-REFERENCE TO RELATED PATENT APPLICATION

This application claims the benefit of priority to the U.S. Provisional Patent Application Ser. No. 63/564,527, filed on Mar. 13, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system and a method, and more particularly to an object tracking system and an object tracking method.

### BACKGROUND OF THE DISCLOSURE

Currently, wireless motion positioning systems often face challenges in the training process due to a lack of feedback mechanisms and insufficient intuitiveness. Without a clear and immediate way for users to provide feedback on the system's performance, it becomes difficult to refine the model and improve accuracy. Additionally, the process may not be user-friendly or intuitive, making it challenging for users to understand how to interact with the system or how their actions impact the results. This can lead to lower efficiency in model training and reduced effectiveness in real-world applications.

Furthermore, certain motion tracking technologies that involve the use of cameras can raise privacy concerns. Since cameras capture detailed visual images of individuals and their surroundings, there is a risk of exposing personal information, violating privacy, and creating discomfort for users.

Therefore, there is a need for systems and methods for tracking and monitoring motion to address the above-mentioned problems and to avoid the above-mentioned drawbacks.

### SUMMARY OF THE DISCLOSURE

In response to the above-referenced technical inadequacies, the present disclosure provides an object tracking system and an object tracking method capable of extending the use of WI-FI sensing technology in tracking application by combining spatial information with motion information while utilizing AR technology to display a target object with its surrounding environment for user, so as to achieve precise three-dimensionally position and motion tracking.

In order to solve the above-mentioned problems, one of the technical aspects adopted by the present disclosure is to provide an object tracking system, which includes a transmitter, a receiver and at least one processing circuit. The transmitter is configured to transmit wireless signals through a target space. The receiver is configured to receive the wireless signals. The at least one processing circuit is configured to perform following processes: obtaining the wireless signals received by the receiver; generating motion information associated with at least one target object by executing a motion machine-learning model that processes the received wireless signals; generating three-dimensional tracking information of the at least one target object with respect to the target space by fusing spatial information of the target space and the motion information; and generating at least one augmented reality (AR) object corresponding to the at least one target object in a digital image corresponding to the target space according to the three-dimensional tracking information.

In order to solve the above-mentioned problems, another one of the technical aspects adopted by the present disclosure is to provide an object tracking method, including: configuring a transmitter to transmit wireless signals through a target space; configuring a receiver to receive the wireless signals; and configuring at least one processing circuit to perform following processes: obtaining the wireless signals received by the receiver; generating motion information associated with at least one target object by executing a motion machine-learning model that processes the received wireless signals; generating three-dimensional tracking information of the at least one target object with respect to the target space by fusing spatial information of the target space and the motion information; and generating at least one augmented reality (AR) object corresponding to the at least one target object in a digital image corresponding to the target space according to the three-dimensional tracking information.

In order to solve the above-mentioned problems, yet another one of the technical aspects adopted by the present disclosure is to provide an object tracking method, adapted to a user equipment including a processor and a memory storing a plurality of executable instructions, and the object tracking method includes: configuring the processor to execute the plurality of executable instructions to perform following processes: configuring an image capturing device to capture at least one panoramic image or at least one panoramic video of a target space; obtaining spatial information generated by executing a spatial machine-learning model that converts the at least one panoramic image or the at least one panoramic video into three-dimensional layout information of the target space; transmitting the spatial information to a network device or a cloud server, wherein the network device or the cloud server is configured to obtain wireless signals received by a receiver, generate motion information associated with at least one target object by executing a motion machine-learning model that processes the received wireless signals, and generate three-dimensional tracking information of the at least one target object with respect to the target space by fusing the spatial information and the motion information; and receiving the three-dimensional tracking information of the at least one target object with respect to the target space, generating and displaying at least one augmented reality (AR) object corresponding to the at least one target object in a digital image corresponding to the target space according to the three-dimensional tracking information by a user interface of a tracking application program executed by the user equipment.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an object tracking system according to one embodiment of the present disclosure;

FIG. 2 is a schematic view showing the object tracking system with respect to a 3D layout of a target space according to one embodiment of the present disclosure;

FIG. 3 is a flowchart of an object tracking method according to one embodiment of the present disclosure;

FIG. 4 is a flowchart of a setup process according to one embodiment of the present disclosure;

FIG. 5 is a schematic view of the setup process according to one embodiment of the present disclosure;

FIG. 6 is a flowchart of processes being performed when the AR-involved motion machine-learning model AMML is executed by the processing circuit according to one embodiment of the present disclosure;

FIG. 7 is a flowchart for training the AR-involved motion machine-learning model AMML according to one embodiment of the present disclosure;

FIG. 8 is a schematic view showing steps of training an initial model by a trained pose-detecting model according to one embodiment of the present disclosure;

FIG. 9 is a flowchart of the training process utilizing AR technique according to one embodiment of the present disclosure;

FIG. 10 is a schematic diagram showing a user interface with detected AR models generated on target objects according to one embodiment of the present disclosure; and

FIG. 11 is another flowchart of the training process according to one embodiment of the present disclosure; and

FIG. 12 is a flowchart of the training process utilizing an infrared image capturing device according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In the present disclosure, an object tracking system and an object tracking method are provided to identify a target object in an environment and track the movement of the target object within the environment using WI-FI sensing technology. A trained spatial machine-learning model can be executed to convert a panorama image into spatial information, and a trained AR-involved motion machine-learning model AMML can be executed to convert WI-FI signal into motion information. The spatial information and the motion information are combined to further identify actions and track movements and location of the target object in the environment.

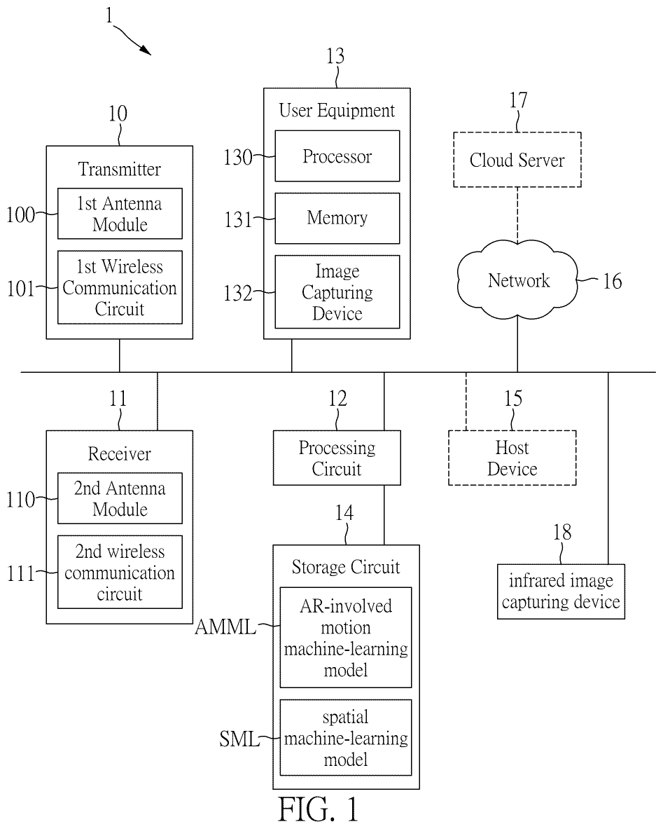

FIG. 1 is a functional block diagram of an object tracking system according to one embodiment of the present disclosure. Referring to FIG. 1, one embodiment of the present disclosure provides an object tracking system 1, and the object tracking system 1 includes a transmitter 10, a receiver 11 and a processing circuit 12.

The transmitter 10 can include a first antenna module 100 and a first wireless communication circuit 101 for controlling a transmitting direction of the first antenna module 100. The first wireless communication circuit 101 can support plural of protocols and may be used to transmit wireless signals having different operation frequencies. Furthermore, the protocols may be wireless communication standard, such as IEEE 802.11, 3G/4G/5G/6G standards.

The first antenna module 100 can be configured to transmit the wireless signals with a plurality of transmitting patterns having different directivities. For example, the first antenna module 100 can include an antenna array with n antenna elements that are arranged in a linear, planar, or circular array, depending on the desired coverage and application. The first wireless communication circuit 101 can be configured to steer the antenna's radiation pattern in n different directions by utilizing beamforming technique, in which phase shifters or time delays are applied to allow for dynamic control of the directionality. Moreover, a switching circuit can be integrated into the first antenna module 100 to select between the n antenna elements or beamforming configurations, the switch circuit can include multiple RF switches or can be a software-controlled signal processing unit. The first wireless communication circuit 101 can be further configured to dynamically select the desired direction based on input parameters, such as signal strength, user location, or specific communication needs. The first antenna module 100 can be used to improve the signal quality of Wi-Fi Sensing Data and further increase the recognition accuracy.

Similarly, the receiver 11 can include a second antenna module 110 and a second wireless communication circuit 111 for controlling a transmitting direction of the second antenna module 110. Similarly, the second wireless communication circuit 111 can support the protocols corresponding to the transmitter 10 and may be used to transmit wireless signals having different operation frequencies.

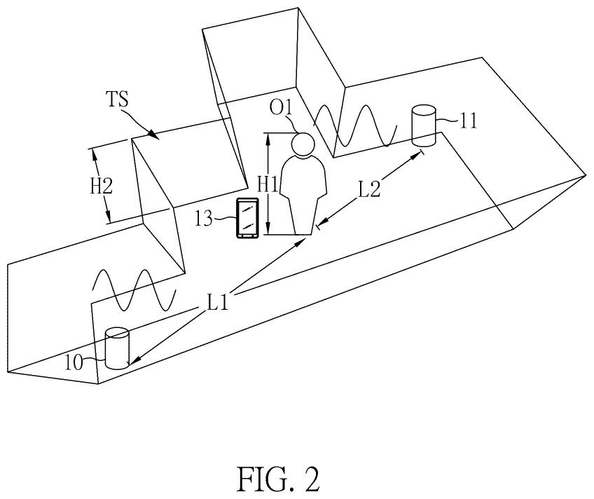

Referring to FIG. 2, when the object tracking system 1 is set in a target space TS, such as an indoor environment of an apartment, the transmitter 10 and the receiver 11 can be separately disposed in two network devices that are disposed at corners of the indoor environment. The two network devices can be, for example, a router and an extender, and in this case, the receiver 11 and the transmitter 10 can be used to provide WI-FI connection while functioning as monitoring devices.

In the present disclosure, a quantity of the processing circuit 12 can be one or more. For example, two processing circuits can be respectively disposed in the two network devices, which respectively include the receiver 11 and the transmitter 10 as mentioned above. In certain embodiments, the processing circuit 12 can be disposed in a cloud server 17 or a host device 15 locally disposed in the indoor environment and communicatively connected with the transmitter 10 and the receiver 11. The processing circuit 12 can be electrically connected to a storage circuit 14, which can be configured to store a spatial machine-learning model SML and an AR-involved motion machine-learning model AMML. In some embodiments, the spatial machine-learning model SML can be stored in the memory of the user equipment 13, and the AR-involved motion machine-learning model AMML can be stored in any storage circuit in the network device at which the processing circuit 12 is disposed.

As shown in FIG. 1, the object tracking system 1 further includes a user equipment 13, such as a mobile phone, which can be communicatively connected to the router and/or the extender. The user equipment 13 can include a processor 130, a memory 131 and an image capturing device 132. The user equipment 13 can also include network interfaces for communicatively connected to the transmitter 10, the receiver 11, the processing circuit(s) 12, the host device 15, the network 16 and/or cloud server 17.

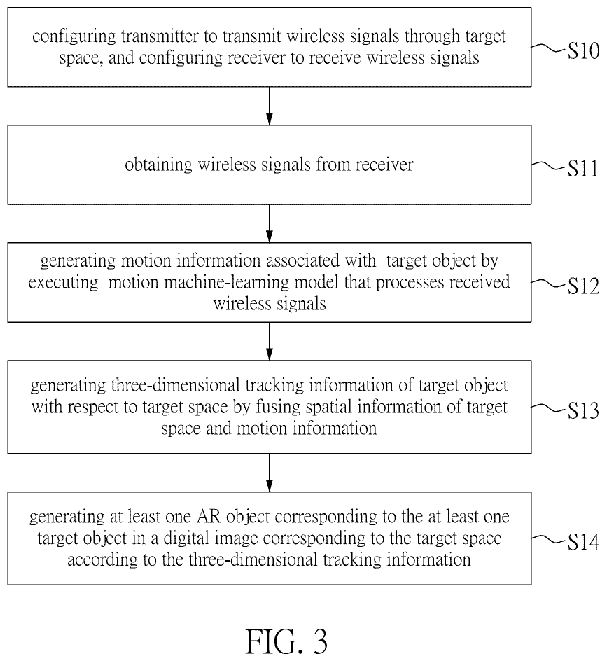

Referring to FIG. 3, the present disclosure provides an object tracking method, which is suitable for the object tracking system 1 of FIG. 1. As shown in FIG. 3, the object tracking method can include the following steps:

Step S10: configuring a transmitter to transmit wireless signals through a target space, and configuring a receiver to receive the wireless signals.

In the present step, the transmitter 10 can transmit radio signals, such as WI-FI signals through a multipath channel, and the receiver 11 can receive the signals from the multipath channel that are impacted by a target object 01 in the indoor environment.

It should be noted that the object tracking method of the present disclosure further includes a setup process that can be performed before step S10. In the setup process, the user equipment 13 can be configured to be communicatively connected to the transmitter 10 and the receiver 11, and to setup and execute an application program by the processor 130. The application program can provide a user interface for the user to manage the network devices and control the image capturing device 132.

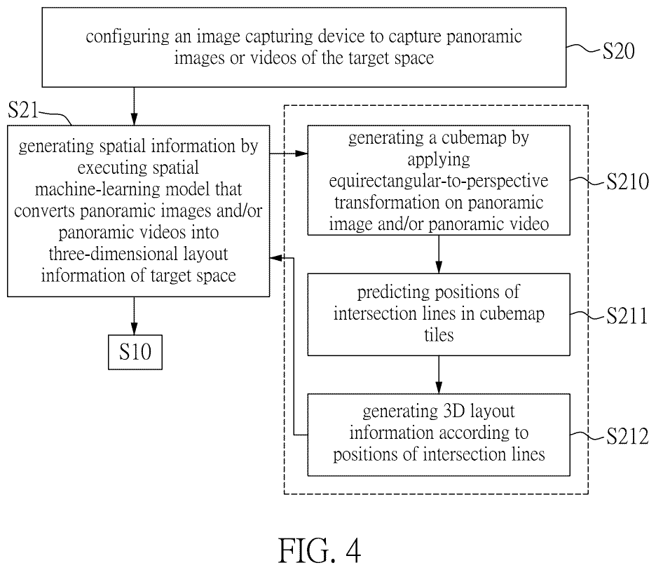

Referring to FIG. 4, the setup process includes the following steps:

Step S20: configuring an image capturing device to capture panoramic images or videos of the target space. For example, the user can control the image capturing device 132 to capture 360-degree panoramic images/videos or 180-degree panoramic images/videos through the user interface provided by the application program.

The setup process further includes the following steps performed by the processing circuit 12 (and/or the processor 130 of the user equipment 13):

Step S21: generating the spatial information by executing a spatial machine-learning model that converts the panoramic images and/or the panoramic videos into three-dimensional layout information of the target space. It should be noted that the spatial information generated in the setup process can be stored in the memory 131 and/or transmitted to the processing circuit 12.

Step S21 further includes the following steps performed for each of the panoramic images and/or the panoramic videos:

Step S210: generating a cubemap by applying an equirectangular-to-perspective transformation on the panoramic image and/or the panoramic video.

Step S211: predicting positions of a plurality of intersection lines in the plurality of cubemap tiles.

Step S212: generating the three-dimensional layout information according to the positions of the plurality of intersection lines.

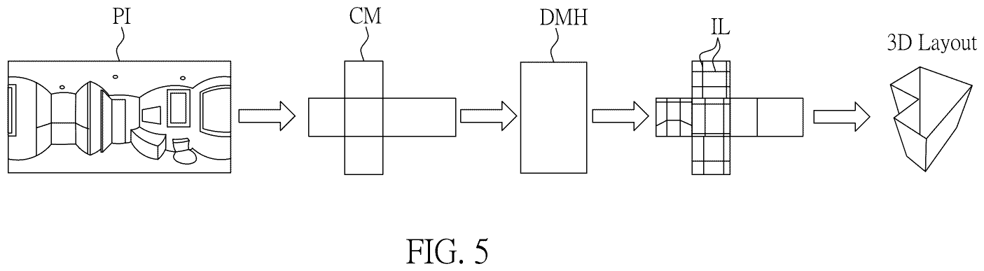

Referring to FIG. 5, the panoramic image is taken as an input of the spatial machine-learning model SML that is executed by the processor 130. During the execution of the spatial machine-learning model SML, an equirectangular-to-perspective (E2P) transformation is applied on the panoramic image PI to generate a cubemap CM. More specifically, the panoramic image is aligned based on an LSD algorithm and vanishing points, then the E2P transformation is conducted for several times on the equal-rectangular image to generate the cubemap CM that includes a plurality of cubemap tiles.

Furthermore, a deep Manhattan Hough (DMH) transform model is then utilized to predict positions of the wall-wall, wall-floor and wall-ceiling intersection lines IL in each of the cubemap tiles. Afterward, a 3D room layout can be recovered by post-processing procedures to serve as the spatial information that includes 3D layout of the target space TS. It should be noted that the spatial information can at least include one or more of geometric information, semantic Information, topological information, and spatial adjacency information. The geometric information includes detailed representations of the physical dimensions and shapes of the target space TS, including walls, floors, ceilings, doors, and windows, the semantic information includes descriptions of the various elements within the space, such as room names, types of furniture, and other objects, the topological information defines relationships and connectivity between different spaces and elements, such as how rooms are connected by doors or hallways, and the spatial adjacency information provides information about the proximity and arrangement of different spaces within the target space TS. In a case that the target space includes multiple rooms, steps S210 to S212 can be repeatedly performed to generate multiple records of the three-dimensional layout information for the rooms, respectively.

Referring to FIG. 3, the object tracking method proceeds to step S11: obtaining the wireless signals from the receiver. During the transmission of the wireless signals, channel state information (CSI) for the multipath channel can be extracted using channel estimation. For example, each component in the CSI can be composed by an amplitude and a phase of a sub-carrier, and when multiple subcarriers arrive at the receiver 11 along the multipath channel, each sub-carrier may have its own amplitude and phase.

Step S12: generating motion information associated with at least one target object by executing a motion machine-learning model that processes the received wireless signals.

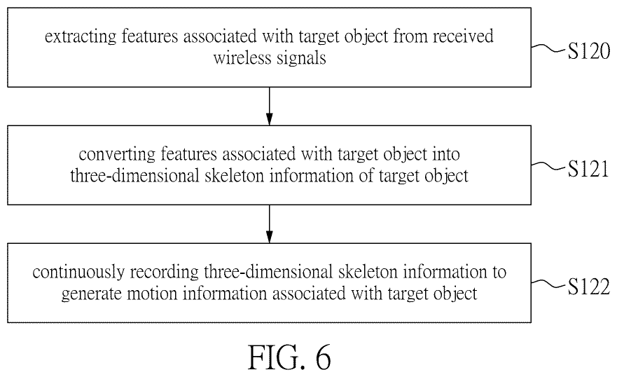

Referring to FIG. 6, the AR-involved motion machine-learning model AMML is executed by the processing circuit 12 to perform following processes:

Step S120: extracting features associated with the at least one target object from the received wireless signals.

For example, when the target object O1 is located in the target space TS, each component in the CSI can be changed by the presence of the target object O1 (human), and when multiple subcarriers arrive at the receiver 11 along the multipath channel, the features associated to the target object O1 can be extracted for motion analyzation.

Step S121: converting the features associated with the at least one target object into three-dimensional skeleton information of the at least one target object.

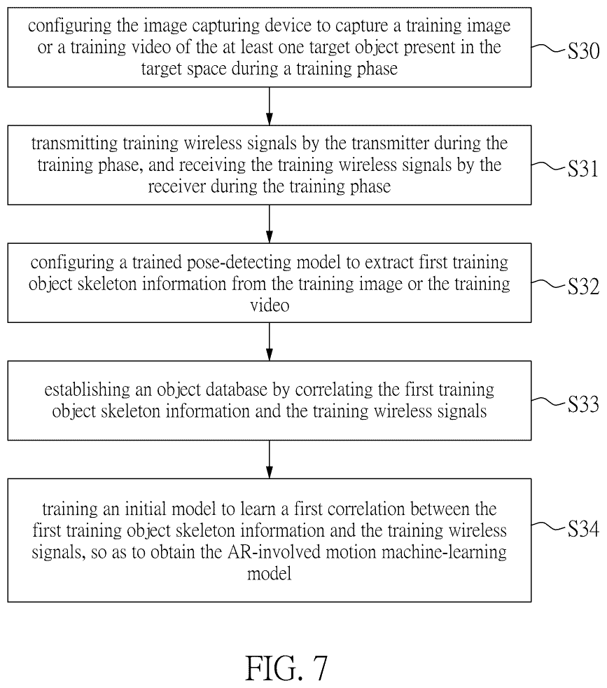

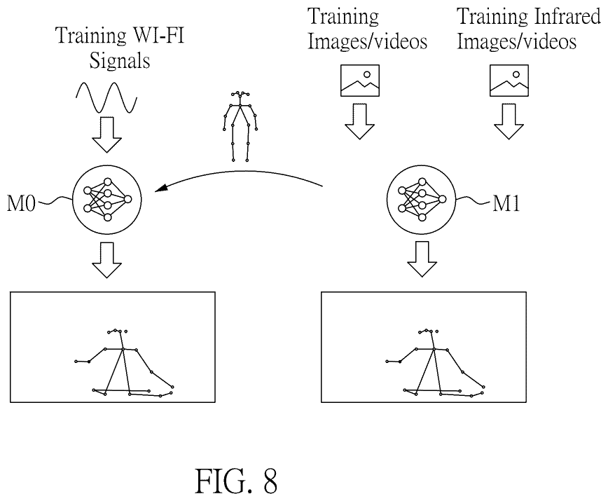

It should be noted that a part of the AR-involved motion machine-learning model AMML has been trained to three-dimensionally detect human skeletons from the wireless signals. Referring to FIGS. 7 and 8, the AR-involved motion machine-learning model AMML is trained by following processes:

Step S30: configuring the image capturing device to capture a training image or a training video of the at least one target object present in the target space during a training phase. The image capturing device 132 in this step is used to take images/videos of one target object to train and enhance the Wi-Fi sensing accuracy. In step S30, the user interface of the application program can instruct the user to set a target object in the target space, such as a room or an environment, and make the target object to move to anywhere in the target space. At the same time, the application program executed by the user equipment 13 further instruct the user to take images and/or videos of the target object inside the room/environment.

Step S31: transmitting training wireless signals by the transmitter during the training phase, and receiving the training wireless signals by the receiver during the training phase. For example, the receiver 11 is configured to receive the training wireless signals while the target object is moving in the room/environment. In some embodiments, data of the training wireless signals can be upload to the cloud server 17 by the receiver 11.

Step S32: configuring a trained pose-detecting model to extract first training object skeleton information from the training image or the training video.

Step S33: establishing an object database by correlating the first training object skeleton information and the training wireless signals.

Step S34: training an initial model to learn a first correlation between the first training object skeleton information and the training wireless signals, so as to obtain the AR-involved motion machine-learning model.

More specifically, the trained pose-detecting model M1 can be a machine-learning model that has been trained to detect and obtain training human skeletons from the training image/video with human therewithin, and human skeleton and/or silhouette, including a body shape, a size, location data, a posture can be obtained from the training image/video. The object database can be established to store the training object skeleton information and the training wireless signals, while storing a correlation between each record of the training object skeleton information and the training wireless signals.

Furthermore, the trained pose-detecting model M1 can serve as a teacher model, such that the initial model M0, serving as a student model, can learn how to detect human skeletons from the wireless signals corresponding to the teacher model's output, that is, the training images or training videos labeled with the training object skeleton information (e.g., human skeletons). In some embodiments, the initial model M0 can include, for example, one or more of a multilayer perceptron model, a convolutional neural network model, a recurrent neural network model, a long-short term memory model and a gated recurrent unit model, and the AR-involved motion machine-learning model AMML can be obtained in response to performance of the initial model MO meeting a predetermined condition.

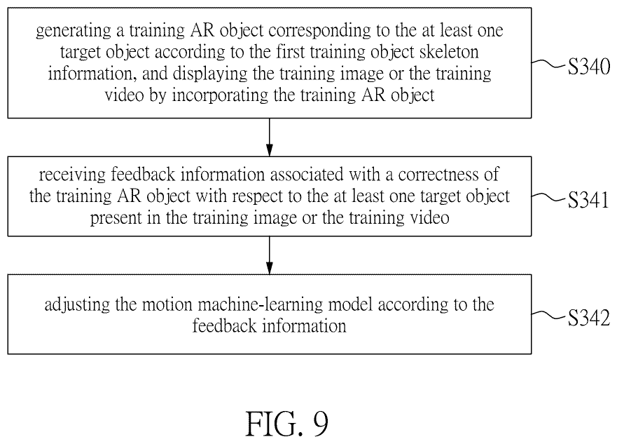

Reference is made to FIG. 9, AR technique can be further utilized in the training process to perform the following steps:

Step S340: generating a training AR object corresponding to the at least one target object according to the first training object skeleton information, and displaying the training image or the training video by incorporating the training AR object.

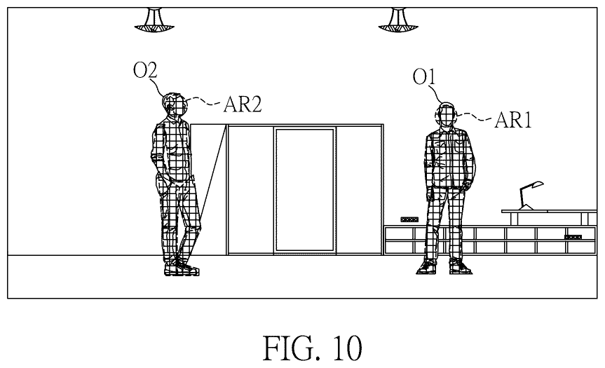

Reference is made to FIG. 10. For example, the application program executed by the user equipment 13 can receive the training human skeletons and the training image/video, and the trained initial model M0 can further detect human skeletons from the training wireless signals during a verification phase. The trained initial model M0 further converts the detected human skeletons into an AR model of the target object, and integrate the AR model with three-dimensional virtual image converted from the target space of the training image/video corresponding to the training wireless signals by using the AR technology. Therefore, the user can see the detected real-time AR models AR1 and AR2 that are directly generated on the target objects O1 and O2 shown in the user interface of the application program for verifying the recognition accuracy.

Step S341: receiving feedback information associated with a correctness of the training AR object with respect to the at least one target object present in the training image or the training video.

Step S342: adjusting the motion machine-learning model according to the feedback information.

In steps S341 and S342, since the user can see the detected real-time AR models AR1 and AR2 in the user interface, the user can compare the AR models AR1 and AR2 respectively with poses and/or status of the target objects O1 and O2 to provide immediate feedback on the recognition result displayed in the user interface to the processing circuit 12. For example, the user can complete a feedback form to specify how the training AR object incorrectly aligns with the target object. The processing circuit 12 can then adjust the parameters of the initial model M0 to calibrate size and height of the training AR object with respect to furniture or objects in the target space based on the received feedback data, enhancing the accuracy of the recognition process.

It should be noted that the target object may exist in a plural quantity. Accordingly, the initial model M0 can be trained either by sequentially setting different target objects one by one or by simultaneously setting multiple target objects in the target space for multi-object training. In certain scenarios, training the initial model M0 with multiple objects can enhance accuracy in determining both the identity of individual objects and the total number of objects.

In steps S341 and S342, the AR model of the target object can be constructed and stored in the storage circuit 14 and/or the memory 131. For different target objects, unique AR models can be obtained and stored. Based on the data from these models, subtle differences in body shape, size, and other characteristics can be identified and combined with the training wireless signals for personal identification.

Furthermore, the transmitter 10 can be configured to use the first antenna module 100 with multi-antenna switching technology to mitigate dead zone issue while improving the signal quality, thereby increasing the accuracy of the AR-involved motion machine-learning model AMML.

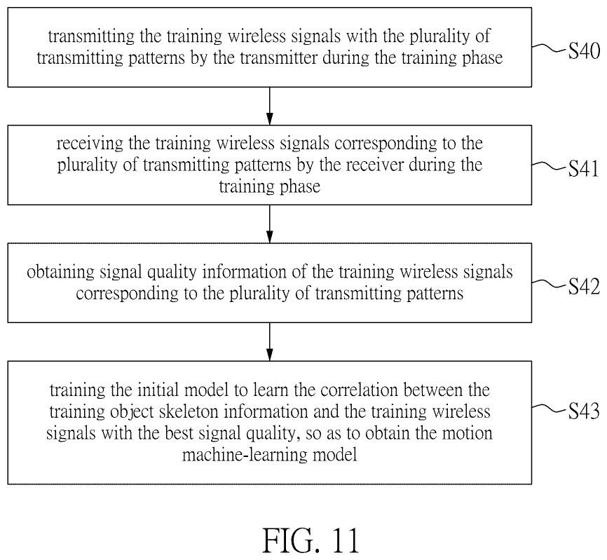

Reference can be made to FIG. 11. The training process can further include following steps:

Step S40: transmitting the training wireless signals with the plurality of transmitting patterns by the transmitter during the training phase.

Step S41: receiving the training wireless signals corresponding to the plurality of transmitting patterns by the receiver during the training phase.

Step S42: obtaining signal quality information of the training wireless signals corresponding to the plurality of transmitting patterns.

Step S43: training the initial model to learn the first correlation between the training object skeleton information and the training wireless signals with the best signal quality, so as to obtain the motion machine-learning model.

For the first antenna module 100 with the n antenna elements, one of the antenna elements is enabled by the first wireless communication circuit 101 to transmit the training wireless signals, and the receiver 11 is configured to collect the training wireless signals. After a predetermined period of time (e.g., T), another one of the antenna elements is enabled, and the receiver 11 is configured to collect the training wireless signals. The processes continues sequentially until data from all antenna elements is collected. The collected data is then analyzed to determine which of the antenna elements provides the best signal quality, and the one with the best signal quality can be used for the training processes to obtain the AR-involved motion machine-learning model AMML with the highest accuracy.

Real-world testing shows that in irregularly shaped rooms, dead spots are a common issue. When the target object is in a dead spot, the wireless signals collected by the receiver 11 may show minimal or no variation, leading to misjudgments. However, such dead-zone issue can be addressed by utilizing antennas with different radiation patterns, and more specifically, different signal propagation directions or transmitting patterns can enhance the wireless signals to be transmitted in these dead spots, significantly improving performance.

After completing the training process, during actual monitoring, such as step S10, if the target object does not carry any electronic device, the primary purpose of the transmitter 10 utilizing multi-antenna switching technique remains to enhance coverage. In this scenario, the operation of the transmitter 10 remains the same as during training.

However, if an electronic device with higher connection priority present in the target space and is communicatively connected to the transmitter 10 for WI-FI connection, the primary purpose of the transmitter 10 utilizing multi-antenna switching technique shifts to improving transmission quality. Once the processing circuit 12 identifies that the electronic device reports certain one of the antenna elements has the best signal quality, the processing circuit 12 is configured to control the first wireless communication circuit 101 to stop switching the antenna elements of the first antenna module 100. Instead, the processing circuit 12 will only restart the antenna scanning process if there is a significant change in the signal quality of the selected one of the antenna elements.

Reference is made to FIG. 6 again. The object tracking method proceeds to step S122: continuously recording the three-dimensional skeleton information to generate the motion information associated with at least one target object.

Reference is made to FIG. 3 again. The object tracking method proceeds to step S13: generating three-dimensional tracking information of the at least one target object with respect to the target space by fusing spatial information of the target space and the motion information.

In step S13, the spatial information provides detail information about the target space TS while the motion information provides real-time movement detection of the target object O1 in the environment. By combining the two, a real-time monitoring of movement for the target object O1 at a precise location of the target space TS can be achieved, which is also helpful if accurate location of a target object in action needs to be identified.

Referring to FIG. 2 again, in step S13, a height H1 of the 3D skeleton of the target object O1 and a height H2 of the target space TS can be estimated by combining the spatial information and the motion information obtained in the previous steps. This calculation can also determine a distance L1 between the target object and the transmitter 10 and a distance L2 between the target object O1 and the receiver 11 (e.g., a distance from the router or the extender to the target object O1), so as to achieve a bird's eye view of human tracking.

Step S14: generating at least one AR object corresponding to the at least one target object in a digital image corresponding to the target space according to the three-dimensional tracking information.

In practical operation, the receiver 11 can be configured to upload data of the collected wireless signals to the processing circuit 12 (e.g., of the cloud server 17). The processing circuit 12 can be configured to analyze the data to determine whether the detected object matches the target object pre-stored in the object database. The previously stored AR models can be further used to generate the AR object and the digital image corresponding to the target space TS, such as shown in FIG. 2.

After completing object tracking, the user can monitor their home or enterprise environment remotely via the application program without needing to install any cameras. Additionally, the application program can utilize the AR object created to generate a 3D virtual image of the target object and display it within the user interface, which allows the user to identify specific objects and calibrate their size and height against furniture or other items in the room or environment.

The three-dimensional tracking information collected by the present disclosure also enables the development of various applications, including fall detection, intrusion detection, presence detection, sleep monitoring, human counting, human tracking, and activity or behavior monitoring.

In some embodiments, the object tracking system 1 can further include an infrared image capturing device 18 for accuracy improvement. The infrared image capturing device 18 can be configured to capture an infrared image of the target space TS. The processing circuit 12 can be further configured to generate the motion information associated with the at least one target object by executing the motion machine-learning model that processes the received wireless signals and the infrared image.

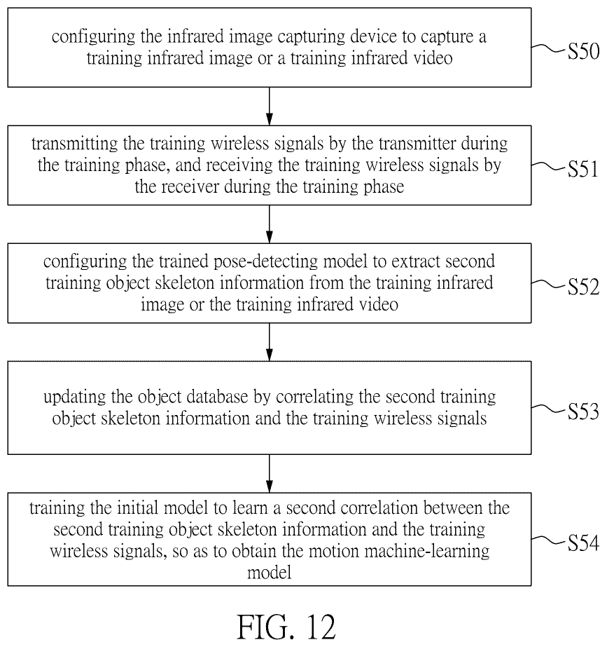

Reference is made to FIG. 12. It should be understood that the training process can be further modified to include the following steps:

Step S50: configuring the infrared image capturing device to capture a training infrared image or a training infrared video.

Step S51: transmitting the training wireless signals by the transmitter during the training phase, and receiving the training wireless signals by the receiver during the training phase.

Step S52: configuring the trained pose-detecting model to extract second training object skeleton information from the training infrared image or the training infrared video.

Step S53: updating the object database by correlating the second training object skeleton information and the training wireless signals.

Step S54: training the initial model to learn a second correlation between the second training object skeleton information and the training wireless signals, so as to obtain the motion machine-learning model.

Reference is made to FIG. 8 again. Similarly, the trained pose-detecting model M1 can be a machine-learning model that has been trained to detect and obtain training human skeletons from the training infrared image/video with human therewithin. The object database created in step S33 can be updated by storing the training object skeleton information obtained from the training infrared image, while storing a correlation between each record of the training object skeleton information obtained from the training infrared image and the training wireless signals.

Therefore, the trained pose-detecting model M1 can serve as a teacher model, such that the initial model M0, serving as a student model, can learn how to detect human skeletons from the wireless signals corresponding to the teacher model's output, that is, the training infrared images or training infrared videos labeled with the training object skeleton information.

One of the key advantages of using the infrared (IR) image capturing device for recognition is its ability to preserve privacy. Unlike traditional cameras that capture detailed visual images, infrared imaging only detects heat signatures and thermal patterns. This means that the captured data does not include personal identifiable features such as facial details, clothing, or other sensitive information. As a result, the IR-based object tracking system provided by the present disclosure can effectively monitor and detect objects or human presence while minimizing privacy concerns, making them an ideal choice for environments where maintaining anonymity and privacy is critical.

The infrared image capturing device 18 can be used to enhance the recognition success rate of the AR-involved motion machine-learning model AMML. When the receiver 11 starts collecting wireless signals, the infrared image capturing device 18 is simultaneously activated. The infrared image captured by the infrared image capturing device 18 can be analyzed by the AR-involved motion machine-learning model AMML to extract information about the detected target object, including its body shape, size, posture, and position. The processing circuit 12 can be configured to combine such information with the obtained wireless signals to improve the recognition accuracy. This approach allows the system to obtain critical information about the detected object-such as body shape, size, posture, and position-without using a traditional camera. This method not only enhances recognition performance but also helps protect user privacy by avoiding the capture of detailed visual images.

Referring to FIG. 1 again, one or more of the image capturing device 134 and the infrared image capturing device 18 can also be included in the transmitter 10 or the receiver 11, and the processing circuit 12, which is singular or plural, can be included in one or more of the user equipment 13, the network devices and/or the host device 15 located in the target space TS, and the cloud server 17. Moreover, the user can input images of family individuals in the house to the processing circuit 12, thereby identifying specific person when movements are detected by performing face detection through real-time video captured by the image capturing device 132. However, the aforementioned details are disclosed for exemplary purposes only, and are not meant to limit the scope of the present disclosure.

### Beneficial Effects of the Embodiments

In conclusion, in the object tracking system and the object tracking method provided by the present disclosure, the use of WI-FI sensing technology can be extended into tracking application by combining the spatial information with the motion information, while utilizing AR technology, so as to achieve precise three-dimensionally position and motion tracking.

Moreover, the object tracking system and the object tracking method provided by the present disclosure integrate a feedback mechanism that allows users to intuitively provide input on the accuracy of the motion tracking, enhancing the training process and improving model accuracy. The integrated feedback mechanism allows users to easily validate or correct recognition results, providing real-time data to improve the model's performance.

Furthermore, the object tracking system and the object tracking method provided by the present disclosure further employ Wi-Fi sensing with infrared (IR) imaging technology to detect motion and body positioning without capturing detailed visual images, thereby preserving user privacy. Simultaneously, an Imaging IR sensor could gather thermal data to refine the accuracy of the motion tracking, ensuring that the system captures essential information like body shape, size, posture, and position without revealing personally identifiable details.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An object tracking system, comprising:
a transmitter configured to transmit wireless signals through a target space;
a receiver configured to receive the wireless signals; and
at least one processing circuit configured to perform following processes:
obtaining the wireless signals received by the receiver;
generating motion information associated with at least one target object by executing a motion machine-learning model that processes the received wireless signals; and
generating three-dimensional tracking information of the at least one target object with respect to the target space by fusing spatial information of the target space and the motion information;
generating at least one augmented reality (AR) object corresponding to the at least one target object in a digital image corresponding to the target space according to the three-dimensional tracking information.

2. The object tracking system according to claim 1, wherein the motion machine-learning model is executed by the at least one processing circuit to perform following process:
extracting features associated with the at least one target object from the received wireless signals;
converting the features associated with the at least one target object into three-dimensional skeleton information of the at least one target object; and
continuously recording the three-dimensional skeleton information to generate the motion information associated with the at least one target object.

3. The object tracking system according to claim 2, wherein the motion machine-learning model is trained by a training process performed for each of the at least one target object, and the training process includes:
configuring an image capturing device to capture a training image or a training video from the at least one target object present in the target space during a training phase;
transmitting training wireless signals by the transmitter during the training phase;
receiving the training wireless signals by the receiver during the training phase;
configuring a trained pose-detecting model to extract first training object skeleton information from the training image or the training video; and
establishing an object database by correlating the first training object skeleton information and the training wireless signals; and
training an initial model to learn a first correlation between the first training object skeleton information and the training wireless signals, so as to obtain the motion machine-learning model.

4. The object tracking system according to claim 3, wherein the training process further includes:
generating a training AR object corresponding to the at least one target object according to the first training object skeleton information, and displaying the training image or the training video by incorporating the training AR object;
receiving feedback information associated with a correctness of the training AR object with respect to the at least one target object presented in the training image or the training video; and
adjusting the motion machine-learning model according to the feedback information.

5. The object tracking system according to claim 4, wherein the transmitter includes an antenna module configured to transmit the wireless signals with a plurality of transmitting patterns having different directivities, and the receiver is configured to receive the wireless signals corresponding to the plurality of transmitting patterns, respectively;
wherein the at least one processing circuit is further configured to perform following processes:
obtaining signal quality information of the wireless signals corresponding to the plurality of transmitting patterns; and
generating the motion information associated with at least one target object by executing the motion machine-learning model that processes the received wireless signals with the best signal quality.

6. The object tracking system according to claim 5, wherein the training process further includes:
transmitting the training wireless signals with the plurality of transmitting patterns by the transmitter during the training phase;
receiving the training wireless signals corresponding to the plurality of transmitting patterns by the receiver during the training phase;
obtaining signal quality information of the training wireless signals corresponding to the plurality of transmitting patterns; and
training the initial model to learn the first correlation between the training object skeleton information and the training wireless signals with the best signal quality, so as to obtain the motion machine-learning model.

7. The object tracking system according to claim 4, further comprising an infrared image capturing device configured to capture an infrared image, wherein the at least one processing circuit is further configured to generate the motion information associated with the at least one target object by executing the motion machine-learning model that processes the received wireless signals and the infrared image.

8. The object tracking system according to claim 7, wherein the training process further includes:
configuring the infrared image capturing device to capture a training infrared image or a training infrared video;
transmitting the training wireless signals by the transmitter during the training phase;
receiving the training wireless signals by the receiver during the training phase;
configuring the trained pose-detecting model to extract second training object skeleton information from the training infrared image or the training infrared video; and
updating the object database by correlating the second training object skeleton information and the training wireless signals; and
training the initial model to learn a second correlation between the second training object skeleton information and the training wireless signals, so as to obtain the motion machine-learning model.

9. The object tracking system according to claim 7, wherein the image capturing device and the infrared image capturing device is included in a user equipment, the transmitter or the receiver, and the at least one processing circuit is included in the user equipment, a network device located in the target space and/or a cloud server;
wherein the user equipment is configured to receive and display the digital image with the at least one AR object corresponding to the at least one target object, and to receive and display the training image or the training video by incorporating the training AR object.

10. An object tracking method, comprising:
configuring a transmitter to transmit wireless signals through a target space;
configuring a receiver to receive the wireless signals; and
configuring at least one processing circuit to perform following processes:
obtaining the wireless signals received by the receiver;
generating motion information associated with at least one target object by executing a motion machine-learning model that processes the received wireless signals; and
generating three-dimensional tracking information of the at least one target object with respect to the target space by fusing spatial information of the target space and the motion information;
generating at least one augmented reality (AR) object corresponding to the at least one target object in a digital image corresponding to the target space according to the three-dimensional tracking information.

11. The object tracking method according to claim 10, wherein the motion machine-learning model is executed by the at least one processing circuit to perform following process:
extracting features associated with the at least one target object from the received wireless signals;
converting the features associated with the at least one target object into three-dimensional skeleton information of the at least one target object; and
continuously recording the three-dimensional skeleton information to generate the motion information associated with the at least one target object.

12. The object tracking method according to claim 11, wherein the motion machine-learning model is trained by a training process performed for each of the at least one target object, and the training process includes:
configuring an image capturing device to capture a training image or a training video of the at least one target object present in the target space during a training phase;
transmitting training wireless signals by the transmitter during the training phase;
receiving the training wireless signals by the receiver during the training phase;
configuring a trained pose-detecting model to extract first training object skeleton information from the training image or the training video; and
establishing an object database by correlating the first training object skeleton information and the training wireless signals; and
training an initial model to learn a first correlation between the first training object skeleton information and the training wireless signals, so as to obtain the motion machine-learning model.

13. The object tracking method according to claim 12, wherein the training process further includes:
generating a training AR object corresponding to the at least one target object according to the first training object skeleton information, and displaying the training image or the training video by incorporating the training AR object;
receiving feedback information associated with a correctness of the training AR object with respect to the at least one target object presented in the training image or the training video; and
adjusting the motion machine-learning model according to the feedback information.

14. The object tracking method according to claim 13, wherein the transmitter includes an antenna module configured to transmit the wireless signals with a plurality of transmitting patterns having different directivities, and the receiver is configured to receive the wireless signals corresponding to the plurality of transmitting patterns, respectively;
wherein the object tracking method further comprises:
configuring the at least one processing circuit to perform following processes:
obtaining signal quality information of the wireless signals corresponding to the plurality of transmitting patterns; and
generating the motion information associated with at least one target object by executing the motion machine-learning model that processes the received wireless signals with the best signal quality.

15. The object tracking method according to claim 14, wherein the training process further includes:
transmitting the training wireless signals with the plurality of transmitting patterns by the transmitter during the training phase;
receiving the training wireless signals corresponding to the plurality of transmitting patterns by the receiver during the training phase;
obtaining signal quality information of the training wireless signals corresponding to the plurality of transmitting patterns; and
training the initial model to learn the first correlation between the training object skeleton information and the training wireless signals with the best signal quality, so as to obtain the motion machine-learning model.

16. The object tracking method according to claim 13, further comprising:
configuring an infrared image capturing device to capture an infrared image; and
configuring the at least one processing circuit to generate the motion information associated with the at least one target object by executing the motion machine-learning model that processes the received wireless signals and the infrared image.

17. The object tracking method according to claim 16, wherein the training process further includes:
configuring the infrared image capturing device to capture a training infrared image or a training infrared video;
transmitting the training wireless signals by the transmitter during the training phase;
receiving the training wireless signals by the receiver during the training phase;
configuring the trained pose-detecting model to extract second training object skeleton information from the training infrared image or the training infrared video;
updating the object database by correlating the second training object skeleton information and the training wireless signals; and
training the initial model to learn a second correlation between the second training object skeleton information and the training wireless signals, so as to obtain the motion machine-learning model.

18. The object tracking method according to claim 16, wherein the image capturing device and the infrared image capturing device is included in a user equipment, the transmitter or the receiver, and the at least one processing circuit is included in the user equipment, a network device located in the target space and/or a cloud server;
wherein the user equipment is configured to receive and display the digital image with the at least one AR object corresponding to the at least one target object, and to receive and display the training image or the training video by incorporating the training AR object.

19. An object tracking method, adapted to a user equipment including a processor and a memory storing a plurality of executable instructions, and the object tracking method comprising:
configuring the processor to execute the plurality of executable instructions to perform following processes:
configuring an image capturing device to capture at least one panoramic image or at least one panoramic video of a target space;
obtaining spatial information generated by executing a spatial machine-learning model that converts the at least one panoramic image or the at least one panoramic video into three-dimensional layout information of the target space;
transmitting the spatial information to a network device or a cloud server, wherein the network device or the cloud server is configured to obtain wireless signals received by a receiver, generate motion information associated with at least one target object by executing a motion machine-learning model that processes the received wireless signals, and generate three-dimensional tracking information of the at least one target object with respect to the target space by fusing the spatial information and the motion information; and
receiving the three-dimensional tracking information of the at least one target object with respect to the target space, generating and displaying at least one augmented reality (AR) object corresponding to the at least one target object in a digital image corresponding to the target space according to the three-dimensional tracking information by a user interface of a tracking application program executed by the user equipment.

20. The object tracking method according to claim 19, further comprising:
configuring an infrared image capturing device to capture an infrared image; and
configuring the network device or the cloud server to generate the motion information associated with the at least one target object by executing the motion machine-learning model that processes the received wireless signals and the infrared image.
